(19) United States
(12) Patent Application Publication
(10) Pub. No.: US 2010/0226709 A1
(43) Pub. Date: Sep. 9, 2010

(54) TANGENTIAL NON-DIMENSIONAL INTERFACE MODULE

(75) Inventors: Geoff Gosling, Alberta (CA); Mogens F. Smed, Alberta (CA)

Correspondence Address: Workman Nydegger;1000 Eagle Gate Tower, 60 East South Temple, Salt Lake City, UT, 84111, US

(73) Assignee: DIRTT ENVIRONMENTAL SOLUTIONS LTD., Calgary (CA)

(21) Appl. No.: 12/717,810

(22) Filed: Mar. 4, 2010

Related U.S. Application Data
(60) Provisional application No. 61/157,529, filed on Mar. 4, 2009.

(51) Int. Cl. F16C 11/04; E04B 1/344

(52) U.S. Cl. 403/24; 403/119; 52/71

(57) ABSTRACT

A connector component comprises opposing angled portions that join with opposing connector interfaces. One connector interface can be used to connect to a structure at a wide range of angles, while the opposing connector interface can be used to connect to another wall with a substantially planar connection. The connector interface provides efficient connection between two structures at a wide range of angles.

### CROSS-REFERENCE TO RELATED APPLICATIONS

The present invention claims the benefit of priority to U.S. Provisional Patent Application No. 61/157,529, filed on Mar. 4, 2009, entitled “TANGENTIAL NON-DIMENSIONAL INTERFACE MODULE,” of which the entire content is incorporated herein by reference.

### BACKGROUND OF THE INVENTION

1. The Field of the Invention

This invention relates to systems, methods, and apparatus for modular wall construction and design.

2. Background and Relevant Art

Curved environments present a significant challenge for modularity. This is at least partly since transitions through the curve can cause a segmentation of modules that historically have required an intervening post to mediate the intersection of the primary (front) walls to intersecting (side) walls.

### BRIEF SUMMARY OF THE INVENTION

Implementations of the present invention comprise a module that allows wall elements to conclude at a single point of tangency. This condition allows any wall type to intersect any other vertical condition at a variety of angles. The tangential quality of the end condition of the detail allows walls to attain an effective thickness of zero as it pertains to elements with which it intersects.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIGS. 1-8 illustrate various schematic views of the tangential non-dimensional interface module (also “bullet,” or “angled connector module”) in accordance with the present invention in both isolated and connected forms.

### DETAILED DESCRIPTION OF THE PREFERRED EMBODIMENTS

Implementations of the present invention comprise a module that allows wall elements to conclude at a single point of tangency. This condition allows any wall type to intersect any other vertical condition at a variety of angles. The tangential quality of the end condition of the detail allows walls to attain an effective thickness of zero as it pertains to elements it is intersecting with.

In addition to the angular attributes that the detail satisfies, it is also capable of intervening at the intersection of any two modules within the system. This feature allows the addition or deletion of an intersecting wall module without disruption to the elements being intersected with. This allows the intersection of 3 or more modules without the need for an intervening post.

A further attribute of the invention is that it allows for modularity in a curved environment. These posts make wholly modular solutions in curved environments impossible. By intervening between adjacent modules as described in the above paragraph, the adverse impact of the post to modularity is avoided.

Although the Figures illustrate one example of the solution, this is by no means limited to this particular shape and form. Preferred elements to the shape are the tangential nature of the end detail, and its ability to connect to an existing system of wall. One will appreciate that a variety of forms can satisfy this behavioral set of attributes.

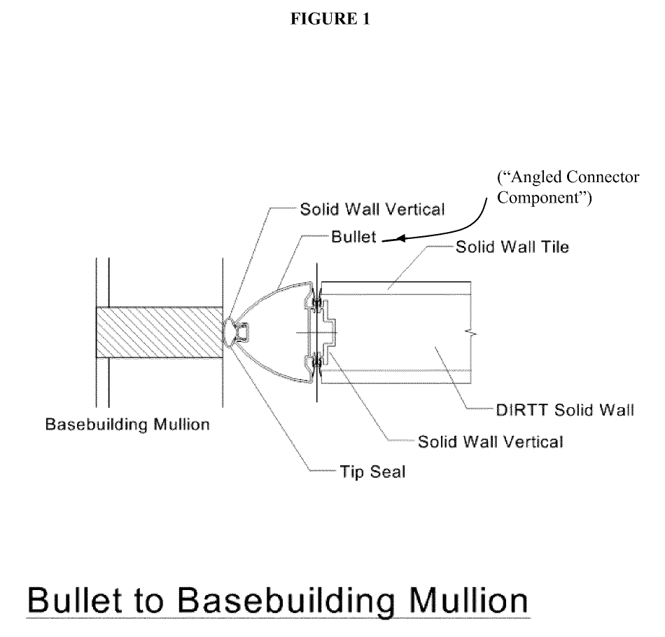

FIGS. 1 through 8 illustrate various aspects of the tangential, non-dimensional module of the present invention. For example, FIG. 1 illustrates a plan view of the tangential module in schematic form, wherein the module is termed a “bullet.” As shown, the tangential module comprises opposing connector interfaces for connecting opposing structures, such as a basebuilding mullion and a modular wall (e.g., DIRTT Solid Wall). These interfaces, in turn, can be connected via a “tip seal” and “solid wall vertical” component, which, from a side view, generally can span a vertical length from floor to ceiling.

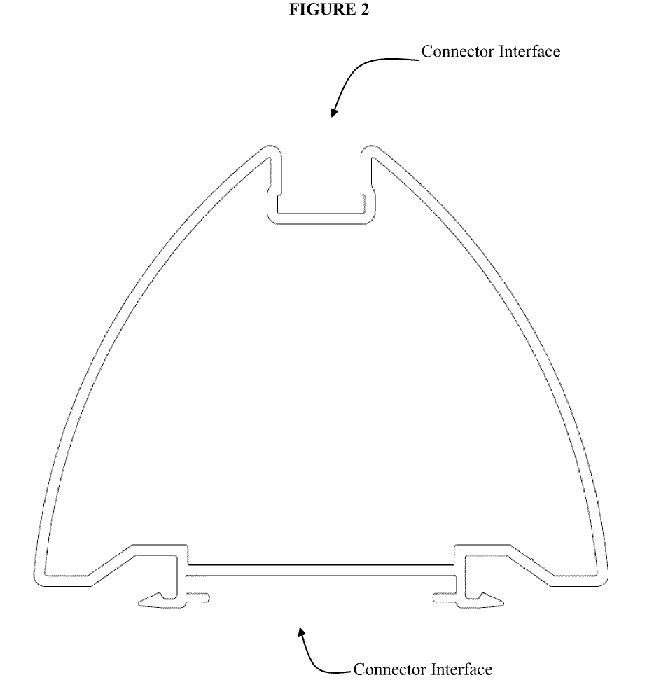

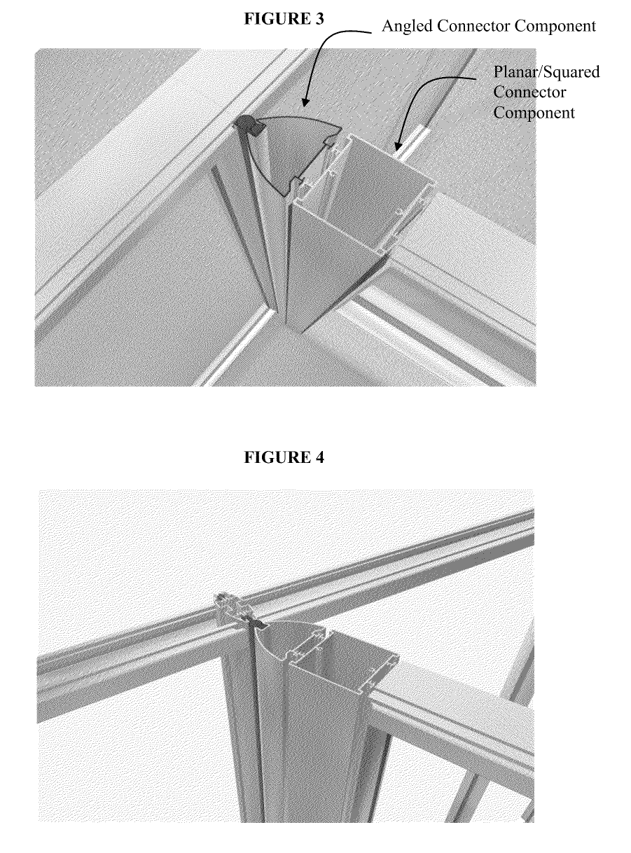

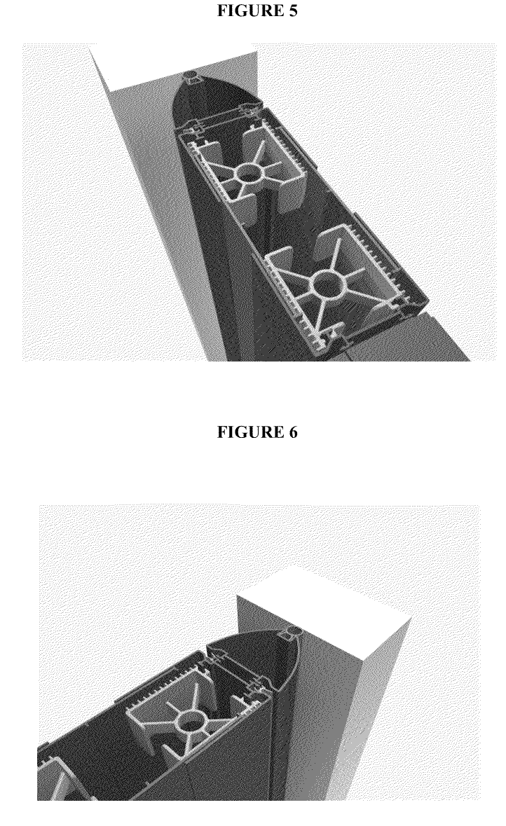

FIG. 2 illustrates another schematic plan view of the connector module, with opposing connector interfaces. As shown, the angled side surfaces of the connector module allow for a wide range of abutment angles with other structures, such as shown more fully herein. For example, FIGS. 3 and 4 illustrates top perspective views of the connector module when used to adjoin two walls in an essentially t-shaped formation. Similarly, FIGS. 5 and 6 illustrate a top, cross-sectional, perspective view of the connector module when used to join a modular wall to a post.

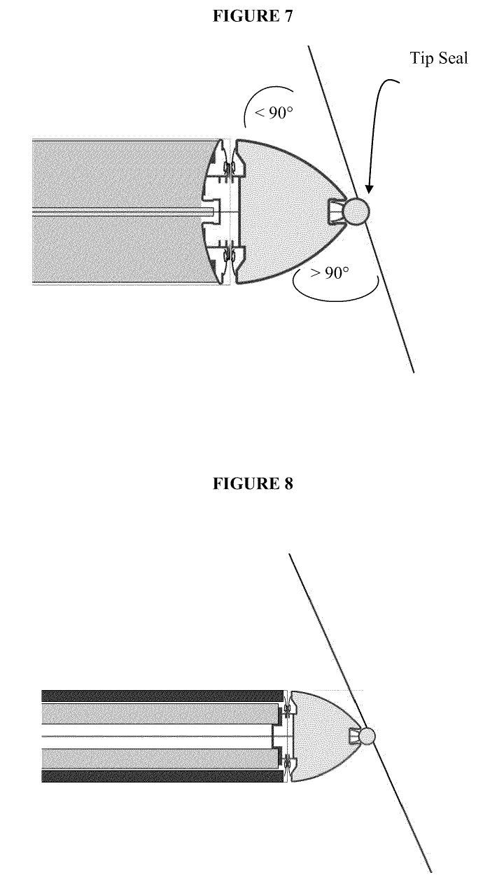

By contrast, FIGS. 7 and 8 illustrate the connector module when used to join a modular wall to another structure (e.g., another wall) at more of an angled conformation (e.g., v-shaped). In particular, FIGS. 7 and 8 show that the connector module, in conjunction with the variable angle “tip seal,” allows adjoining wall modules to join together at a much wider range of angles than possible using conventional connectors, such as angles much less than or greater than 90° , or otherwise approaching 0° or 180° .

To facilitate each of the above-described concepts and mechanisms, FIGS. 1-8 show that the angled connector component comprises an angled end for one connector interface, which is opposite a substantially planar end for the other, opposing connector interface (see, e.g., FIG. 2). As shown in the Figures, the planar end of the angled connector component is used to create a secure and stable connection to the end of a structure, such as a wall module. By contrast, the angled end enables an assembler to connect the structure at the planar end in a transverse manner to another structure, such as another wall module. As previously mentioned, the angled end, in conjunction with the tip seal, allows for significant variability in transversely connecting the two different structures at a particular angle.

One will appreciate that the connector module can be configured for connection to a wide range of other modular components, as desired, in order to ensure that modular structures are connected together in the appropriate conformation or angle. For example, at least FIGS. 3 and 4 show that the connector module can connect to a wall structure indirectly via yet another modular connector, albeit a primarily squared such component.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A connector component configured to flexibly connect adjoining structures at one or more angles greater than or less than 90 degrees, wherein the connector component comprises:
an angled end having a first connector interface; and
a substantially planar end having an opposing second connector interface;
wherein the opposing first and second connector interfaces provide for transverse connections between two wall at a plurality of angles.
